(19) United States
(12) Patent Application Publication
(10) Pub. No.: US 2008/0117129 A1
(43) Pub. Date: May 22, 2008

(54) Plasma display device and driving method thereof

(76) Inventors: Seongjoon Jeong, Yongin-si (KR); Woojoon Chung, Yongin-si (KR); Seungwon Choi, Yongin-si (KR)

Correspondence Address: ROBERT E. BUSHNELL, 1522 K STREET NW, SUITE 300, WASHINGTON, DC, 20005-1202, US

(21) Appl. No.: 11/882,732

(22) Filed: Aug. 3, 2007

(30) Foreign Application Priority Data
Nov. 22, 2006 (KR) 10-2006-0116046

(51) Int. Cl. G09G 3/28

(52) U.S. Cl. 345/60

(57) ABSTRACT

A plasma display device includes: a plurality of first electrodes, a plurality of second electrodes, a plurality of third electrodes intersecting the first and second electrodes, and a plurality of discharge cells divided into first and second discharge cell groups, the plasma display device representing a gray scale using a unit frame consisting of a combination of a plurality of sub-fields, and its driving method includes: a first address step of selecting discharge cells to be lit from the first discharge cell group; a first sustain step of creating sustain discharges in the discharge cells during the first address step; a second address step of selecting discharge cells to be lit from the second discharge cell group; and a second sustain step of creating sustain discharges in the discharge cells during the second address step; respective rising slopes of the last sustain pulse supplied to one of the first and second electrodes in each of the first and second steps are different from each other.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filed in the Korean Intellectual Property Office on 22 Nov. 2006 and there duly assigned Serial No. 2006-0116046.

### BACKGROUND OF THE INVENTION

1. Field of the Invention

The present invention relates to a plasma display device and a driving method thereof, and more particularly, the present invention relates to a plasma display device and a driving method thereof having improved low gray scale representation.

2. Description of the Background Art

A plasma display device employs a Plasma Display Panel (PDP) to display letters or images using a plasma created by a gas discharge. For this purpose, a plasma display device includes a PDP to implement images and a plurality of driving circuit elements to drive the PDP.

The PDP of the plasma display device is driven with a frame divided into a plurality of sub-fields each having a weight value. A light emission cell and a non-light emission cell are selected for an address period of each sub-field, and a sustain discharge is carried out on the light emission cell to display images for a sustain period. A gray scale is represented by a combination of the weight values of the sub-fields for which a cell emits light.

The plasma display device calculates an Automatic Power Control (APC) level in accordance with a detected load factor for externally inputted image data and yields a total number of sustain pulses corresponding to the calculated APC level. The plasma display device prevents its power consumption from exceeding a constant level by reducing the total number of sustain pulses inputted within a frame according to the APC level when the load is too high to display images for a frame. In this case, a difference in the number of pulses between a sub-field having the minimum weight value and its neighboring sub-field is two. Therefore, a lowering of gray-scale linearity often occurs between APC levels in applying the APC.

Moreover, a plasma display device has a limitation in providing a desired brightness level only when the number of sustain pulses assigned to each sub-field is at a constant rate.

### SUMMARY OF THE INVENTION

Accordingly, the present invention has been made to solve the above-mentioned problems occurring in the prior art, and an object of the present invention is to provide a plasma display device and a driving method thereof having improved low gray scale representation.

According to one aspect of the present invention, a method of driving a plasma display device including a plurality of first electrodes, a plurality of second electrodes, a plurality of third electrodes arranged to intersect the first and the second electrodes, and a plurality of discharge cells divided into a first discharge cell group and a second discharge cell group, the plasma display device representing a gray scale using a unit frame consisting of a combination of a plurality of sub-fields is provided, the method including: a first address step of selecting discharge cells to be lit from the first discharge cell group; a first sustain step of creating sustain discharges in the discharge cells selected in the first address step; a second address step of selecting discharge cells to be lit from the second discharge cell group; and a second sustain step of creating sustain discharges in the discharge cells selected in the second address step; respective rising slopes of a last sustain pulse supplied to the first and the second electrodes in each of the first and second sustain steps are different from each other.

The first discharge cell group preferably includes discharge cells defined by first odd-numbered electrodes among the first electrodes, and the second discharge cell group preferably includes discharge cells defined by first even-numbered electrodes among the first electrodes.

The first discharge cell group preferably includes discharge cells defined by the first electrodes and the second electrodes, each of which is located above each of the first electrodes, and the second discharge cell group preferably includes discharge cells defined by the first electrodes and the second electrodes, each of which is located below each of the first electrodes.

The rising slope of the last sustain pulse supplied to either the first electrodes or the second electrodes is preferably smaller than a rising slope of the other sustain pulses, for the first sustain step, and the rising slope of the last sustain pulse supplied to either the first electrodes or the second electrodes is preferably equal to a rising slope of the other sustain pulses, for the second sustain step.

The rising slope of the last sustain pulse supplied to either the first electrodes or the second electrodes is preferably equal to a rising slope of the other sustain pulses, for the first sustain step, and the rising slope of the last sustain pulse supplied to either the first electrodes or the second electrodes is preferably smaller than a rising slope of the other sustain pulses, for the second sustain step.

The rising slope of the last sustain pulse supplied to either the first electrodes or the second electrodes is preferably smaller than a rising slope of the other sustain pulses, for the first sustain step, and the rising slope of the last sustain pulse supplied to either the first electrodes or the second electrodes is preferably equal to a rising slope of the other sustain pulses, for the second sustain step.

The rising slope of the last sustain pulse supplied to either the first electrodes or the second electrodes is preferably equal to a rising slope of the other sustain pulses, for the first sustain step, and the rising slope of the last sustain pulse supplied to either the first electrodes or the second electrodes is preferably smaller than a rising slope of the other sustain pulses, for the second sustain step.

The method preferably further includes: a first reset step of initializing the first discharge cell group prior to the first address step; and a second reset step of initializing the second discharge cell group prior to the second address step.

According to another aspect of the present invention, a method of driving a plasma display device including a plurality of first electrodes, a plurality of second electrodes, a plurality of third electrodes arranged to intersect the first and the second electrodes, and a plurality of discharge cells divided into a first discharge cell group and a second discharge cell group, the plasma display device representing a gray scale using a unit frame consisting of a combination of a plurality of sub-fields is provided, the method including: a jth sub-field (where, j is a natural number) among a plurality of sub-fields included in an ith frame (where, i is a natural number) includes a first sustain period in which a first amount of light is generated and a second sustain period in which a second amount of light is generated, and a jth sub-field among a plurality of sub-fields included in a i+1th frame includes a first sustain period in which the second amount of light is generated and a second sustain period in which the first amount of light is generated.

The jth sub-field of the ith frame preferably includes: a first address step of selecting discharge cells to be lit from the first discharge cell group; a first sustain step of creating sustain discharges in the discharge cells selected in the first address step, during the first sustain period; a second address step of selecting discharge cells to be lit from the second discharge cell group; and a second sustain step of creating sustain discharges in the discharge cells selected in the second address step, during the second sustain period, and the jth sub-field of the i+1th frame preferably includes: a first address step of selecting discharge cells to be lit from the second discharge cell group; a first sustain step of creating sustain discharges in the discharge cells selected in the first address step, during the first sustain period; a second address step of selecting discharge cells to be lit from the first discharge cell group; and a second sustain step of creating sustain discharges in the discharge cells selected in the second address step, during the second sustain period.

The first discharge cell group preferably includes discharge cells defined by first odd-numbered electrodes among the first electrodes, and the second discharge cell group preferably includes discharge cells defined by first even-numbered electrodes among the first electrodes.

The first discharge cell group preferably includes discharge cells defined by the first electrodes and the second electrodes, each of which is located above each of the first electrodes, and the second discharge cell group preferably includes discharge cells defined by the first electrodes and the second electrodes, each of which is arranged below each of the first electrodes.

A rising slope of a last sustain pulse supplied to either the first electrodes or the second electrodes during the first sustain step is preferably smaller than a rising slope of the other sustain pulses, and a rising slope of the last sustain pulse supplied to either the first electrodes or the second electrodes during the second sustain step is preferably equal to a rising slope of the other sustain pulses.

A rising slope of the last sustain pulse supplied to either the first electrodes or the second electrodes during the first sustain step is preferably smaller than a rising slope of the other sustain pulses, and a rising slope of the last sustain pulse supplied to either the first electrodes or the second electrodes during the second sustain step is preferably equal to a rising slope of the other sustain pulses.

The method preferably further includes a first reset step of initializing the first discharge cell group prior to the first address step; and a second reset step of initializing the second discharge cell group prior to the second address step.

According to yet another aspect of the present invention, a plasma display device is provided including: a Plasma Display Panel (PDP) including a plurality of first electrodes, a plurality of second electrodes, a plurality of third electrodes arranged to intersect the first and the second electrodes, and a plurality of discharge cells divided into a first discharge cell group and a second discharge cell group; a controller dividing a frame into a plurality of sub-fields, the controller controlling at least one of the plurality of sub-fields to have first and second sustain periods; and a driver supplying sustain pulses to the plurality of the first electrodes, respective rising slopes of a last sustain pulse supplied to the first electrode in each of the first and second steps are different from each other.

The first discharge cell group preferably includes discharge cells defined by first odd-numbered electrodes among the first electrodes, and the second discharge cell group preferably includes discharge cells defined by first even-numbered electrodes among the first electrodes.

The first discharge cell group preferably includes discharge cells defined by the first electrodes and the second electrodes, each of which is arranged above each of the first electrodes, and the second discharge cell group preferably includes discharge cells defined by the first electrodes and the second electrodes, each of which is arranged below each of the first electrodes.

The driver preferably supplies the last sustain pulse having a rising slope equal to a rising slope of the other sustain pulses to the first electrodes for the first sustain step, and preferably supplies the last sustain pulse having a rising slope smaller than a rising slope of the other sustain pulses to the first electrodes for the second sustain step.

The driver preferably supplies the last sustain pulse having a rising slope smaller than a rising slope of the other sustain pulses to the first electrodes for the first sustain step, and preferably supplies the last sustain pulse having a rising slope equal to a rising slope of the other sustain pulses to the first electrodes for the second sustain step.

Further objects and advantages of the present invention will be more fully understood from the following detailed description taken in conjunction with the accompanying drawings.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display device according to an embodiment of the present invention;

FIG. 2 is a diagram of a part frame for which images are displayed by a plasma display device according to an embodiment of the present invention;

FIG. 3a and FIG. 3b are driving waveforms supplied to each sub-field in a plasma display device according to a first embodiment of the present invention;

FIG. 4a and FIG. 4b are driving waveforms supplied to each sub-field in a plasma display device according to a second embodiment of the present invention;

FIG. 5 is a diagram of discharge cells of a plasma display device according to a third embodiment of the present invention; and

FIG. 6 is a driving waveform supplied to each sub-field in the plasma display device according to the third embodiment of the present invention.

### DETAILED DESCRIPTION OF THE INVENTION

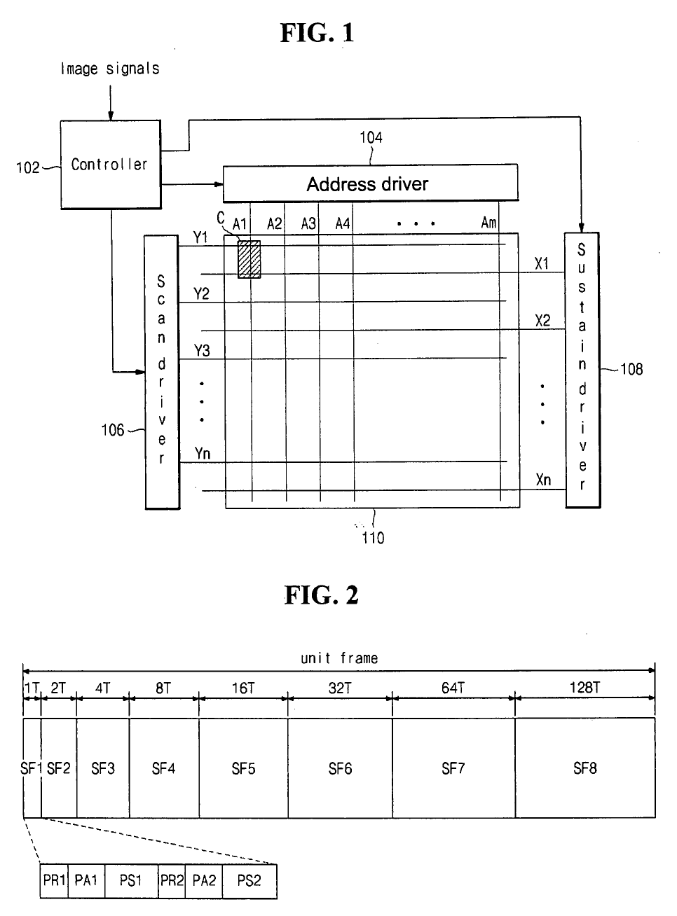

Exemplary embodiments of the present invention are described below in more detail with reference to FIGS. 1 to 6.

FIG. 1 is a block diagram of a plasma display device according to the present invention.

Referring to FIG. 1, a plasma display device according to the present invention includes: a PDP 110 displaying images thereon; an address driver 104 supplying data to address electrodes A1 to Am of the PDP 110; a scan driver 106 driving scan electrodes Y1 to Yn; a sustain driver 108 driving sustain electrodes X1 to Xn; and a controller 102 controlling the drivers 104, 106, and 108.

The PDP 110 displays images using a plurality of discharge cells C arranged in a matrix form. The discharge cells C are defined by a plurality of address electrodes (referred to as the third electrodes) A1 to Am extending in a column direction, a plurality of scan electrodes (referred to as the first electrodes) Y1 to Yn extending in a row direction, and a plurality of sustain electrodes (referred to as the second electrodes) X1 to Xn extending in parallel with the scan electrodes Y1 to Yn. The address electrodes A1 to Am are arranged to intersect the scan electrodes Y1 to Yn and sustain electrodes X1 to Xn.

On the other hand, the odd-numbered scan electrodes Y1, Y3, . . . , Yn-1; Yo of the scan electrodes and odd-numbered sustain electrodes X1, X3, . . . , Xn-1; Xo of the sustain electrodes constitute discharge cells, which are grouped to form a first discharge cell group G1, and the even-numbered scan electrodes Y2, Y4, . . . , Yn; Ye of the scan electrodes and even-numbered sustain electrodes X2, X4, . . . , Xn; Xe of the sustain electrodes constitute discharge cells, which are grouped to form a second discharge cell group G2. These first and second discharge cell groups G1 and G2 each are driven separately to perform a reset discharge, an address discharge, and a sustain discharge. The driving method thereof is described later.

The controller 102 controls each driver, with a frame divided into a plurality of sub-fields, each of which consists of a reset period, an address period, and a sustain period. The controller 102 receives vertical/horizontal synchronization signals and generates an address control signal, a scan control signal, and a sustain control signal required for each driver 104, 106, and 108. The generated control signals are supplied to the corresponding drivers 104, 106, and 108, so that the controller 102 may control each of drivers 104, 106, and 108.

In addition, the controller 102 estimates a load factor and an APC level corresponding to the load factor from inputted image signals and determines the number of sustain pulses. The controller 102 controls the ON/OFF function of a plurality of switching elements included in the scan driver 106 and sustain driver 108 to correspond the determined number of sustain pulses. In particular, the controller 102 controls the ON/OFF function of a plurality of switching elements included in the scan driver 108 which generates sustain pulses supplied for the sustain period, creating strong discharges and weak discharges.

The address driver 104 supplies data signals to each address electrode A to select discharge cells to be displayed in response to the address control signals from the controller 102.

The scan driver 106 supplies driving voltages to the scan electrodes Y1 to Yn in response to the scan control signals from the controller 102. In more detail, the scan driver 106 supplies the sustain pulses to the scan electrodes Y in such a manner that the last sustain pulse is similar or dissimilar in form to the other sustain pulses.

The sustain driver 108 supplies driving voltages to the sustain electrodes X in response to the sustain control signals from the controller 102.

FIG. 2 is a diagram of a part frame for which images are displayed by a plasma display device according to an embodiment of the present invention.

Referring to FIG. 2, a unit frame, for which images are displayed, is divided into a plurality of sub-fields. The part frame may include eight sub-fields, each of which may include a first reset period PR1, a first address period PA1, a first sustain period PS1, a second reset period PR2, a second address period PA2, and a second sustain period PS2, as shown in FIG. 2.

The first reset period PR1 is a time period for initializing all of the discharge cells included in the first discharge cell group G1, and the first address period PA1 is a time period for addressing the discharge cells included in the first discharge cell group G1. Discharge cells to be lit and discharge cells not to be lit are divided among the discharge cells included in the first discharge cell group G1. The first sustain period PS1 is a time period for creating a prescribed number of sustain discharges at the discharge cells selected (addressed) for the first address period PA1. The number of sustain discharges can be adjusted depending on a designer's intention. All of the discharge cells included in the second discharge cell group G2 are not initialized for the first reset period PR1 and the discharge cells included in the second discharge cell group G2 are not initialized for the first address period PA1, and thus, addressing is not performed. Therefore, a sustain discharge is not performed at the second discharge cell group G2 for the first sustain period PS1.

The second reset period PR2 is a time period for initializing all of the discharge cells included in the second discharge cell group G2, and the second address period PA2 is a time period for addressing the discharge cells included in the second discharge cell group G2. Discharge cells to be lit and discharge cells not to be lit are divided among the discharge cells included in the second discharge cell group G2. The second sustain period PS2 is a time period for creating a prescribed number of sustain discharges at the discharge cells selected (addressed) for the second address period PA2. The initialization and addressing is not performed at the first discharge cell group G1 for the second reset period PR2 and second address period PA2, respectively.

A unit frame is divided into eight sub-fields SF1 to SF8 and gray scan weight values of 1T, 2T, . . . , and 128T, respectively, and are assigned to each of the first sub-field SF1 to the eighth sub-field SF8 of FIG. 2. However, the present invention is not limited thereto. That is, the number of the sub-fields in the unit frame may be more or less than eight, and the assignment of gray scale weight values to each sub-field may be different than the above example depending on the design specification.

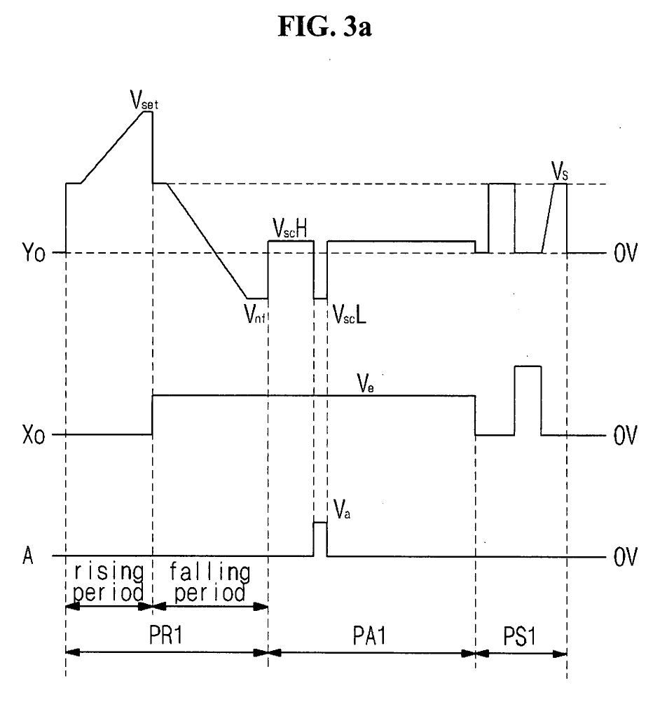

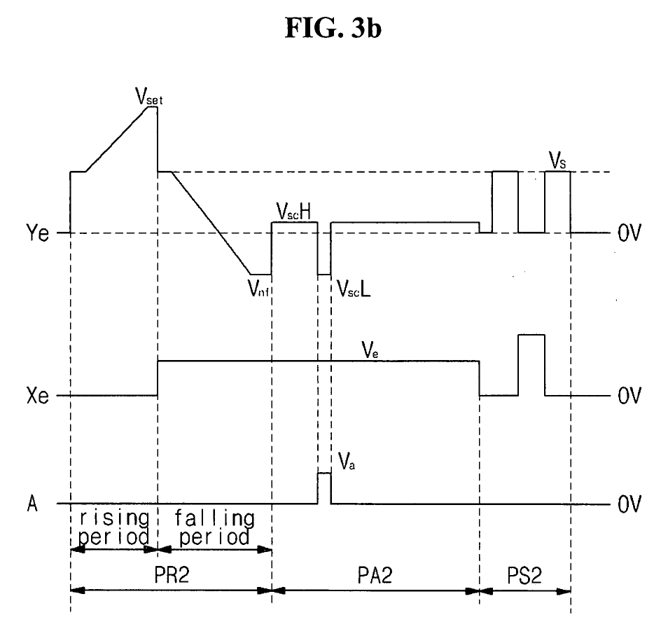

FIGS. 3a and 3b are detailed driving waveforms supplied for the reset period, address period, and sustain period of FIG. 2.

Referring to FIG. 3a, a rising ramp pulse, which rises gradually from Vs to Vset, is supplied to the odd-numbered scan electrodes Yo, while a reference voltage (‘0V’ in FIG. 3a) is supplied to the odd-numbered sustain electrodes Xo for a rising period of the first reset period PR1 in each sub-field. Then, a weak discharge occurs between the odd-numbered scan electrodes Yo and the odd-numbered sustain electrodes Xo and between the odd-numbered scan electrode Yo and the address electrodes A while the voltage supplied to the odd-numbered scan electrodes Yo increases.

A voltage supplied to the odd-numbered scan electrodes Yo gradually falls from Vs to Vnf while a voltage Ve is supplied to the odd-numbered sustain electrodes Xo for the falling period of the first reset period PR1. Then, a weak reset discharge occurs between the odd-numbered scan electrodes Yo and the odd-numbered sustain electrodes Xo and between the odd-numbered scan electrodes Yo and address electrodes A while the voltage supplied to the odd-numbered scan electrodes Yo decreases, to initialize the discharge cells.

Some of the odd-numbered scan electrodes Yo are sequentially supplied with a scan pulse having a voltage VscL and the other of the odd-numbered scan electrodes Yo not supplied with the voltage VscL are supplied with a voltage VscH for the first address period PA1 in order to select discharge cells to be lit. An address pulse having a voltage Va is supplied to some of address electrodes A, which pass through the discharge cells to be selected among the plurality of discharge cells formed by the odd-numbered scan electrodes Yo supplied with the voltage VscL, and a reference voltage (‘0V’ in FIG. 3a) is supplied to the other address electrodes A. The voltage VscL is set to have the same voltage level as the voltage Vnf at the first reset period PR1 in FIG. 3a. Then, an address discharge occurs at the discharge cells formed by the address electrodes A supplied with the voltage Va and the odd-numbered scan electrodes Yo supplied with the voltage VscL.

The odd-numbered scan electrodes Yo and the odd-numbered sustain electrodes Xo are alternately supplied with ramp-waveform sustain pulses which have a high level voltage (‘Vs’ in FIG. 3a) and a low level voltage (‘0V’ in FIG. 3a) for the first sustain period PS1, wherein a slope from the high level voltage to the low level voltage or from the low level voltage to the high level voltage is a constant. That is, a first sustain pulse alternated by a high level voltage Vs and a low level voltage 0V is supplied to the odd-numbered scan electrodes Yo, and a second sustain pulse having an opposite phase to the first sustain pulse is supplied to the odd-numbered sustain electrodes Xo. Accordingly, a sustain discharge occurs between the odd-numbered scan electrodes Yo and odd-numbered sustain electrodes Xo of the discharge cells to be lit. The rising slope of the last sustain pulse of the sustain pulses supplied to the odd-numbered scan electrodes Yo, i.e. the slope from the low level voltage 0V to the high level voltage Vs, is smaller than the rising slope of the other sustain pulses. Thus, if the voltage supplied to the discharge cells selected for the address period exceeds a firing voltage between the odd-numbered scan electrodes Yo and the odd-numbered sustain electrodes Xo, then a weak sustain discharge occurs between the odd-numbered scan electrodes Yo and odd-numbered sustain electrodes Xo. In this case, the amount of light generated for the first sustain period PS1 is relatively small, because the last sustain discharge among the sustain discharges occurring between the odd-numbered scan electrodes Yo and odd-numbered sustain electrodes Xo is weak.

Referring to FIG. 3b, a waveform equal to the waveform supplied for the first reset period PR1 is supplied to the even-numbered scan electrodes Ye and even-numbered sustain electrodes Xe for the second reset period PR2. The second reset period PR2 may also include only the falling period. In this case, a voltage supplied to the even-numbered scan electrodes Ye gradually decreases to reach a voltage Vnf while a voltage Ve is supplied to the even-numbered sustain electrodes Xe for the second reset period PR2. Then, a weak reset discharge occurs between the even-numbered scan electrodes Ye and the even-numbered sustain electrodes Xe and between the even-numbered scan electrodes Ye and address electrode A while the voltage supplied to the even-numbered scan electrodes Ye decreases, to initialize the discharge cells.

The same waveforms as those of the first address period PA1 are supplied to the even-numbered scan electrodes Ye, the even-numbered sustain electrodes Xe, and address electrodes A for the second address period PA2, and thus a detailed description for the second address period has been omitted.

The even-numbered scan electrodes Ye and the even-numbered sustain electrodes Xe are alternately supplied with ramp-waveform sustain pulses which have a high level voltage (‘Vs’ in FIG. 3b) and a low level voltage (‘0V’ in FIG. 3b) for the second sustain period PS2, wherein a slope from the high level voltage to the low level voltage or from the low level voltage to the high level voltage is a constant. Accordingly, a sustain discharge occurs between the even-numbered scan electrodes Ye and even-numbered sustain electrodes Xe of the discharge X cells to be lit. The rising slope of the last sustain pulse of the sustain pulses supplied to the even-numbered scan electrodes Ye, i.e. the slope from the low level voltage 0V to the high level voltage Vs, is equal to the rising slope of the other sustain pulses. Thus, if the voltage supplied to the discharge cells selected for the address period exceeds a firing voltage between the even-numbered scan electrodes Ye and the even-numbered sustain electrodes Xe, then a weak sustain discharge occurs between the even-numbered scan electrodes Ye and even-numbered sustain electrodes Xe. The sustain discharge of the second sustain period PS2 is greater than the sustain discharge of the first sustain period PS1. Therefore, the amount of light generated during the second sustain period PS2 is greater than the amount of light generated during the first sustain period PS1.

As such, the plasma display device and the driving method thereof can set the desired amount of light to an average of the amount of light generated during the first sustain period and the amount of light generated during the second sustain period in a low gray scale sub-field including the first and second sustain periods. As a consequence, the plasma display device according to the present invention has improved low gray scale representation as compared to the prior art.

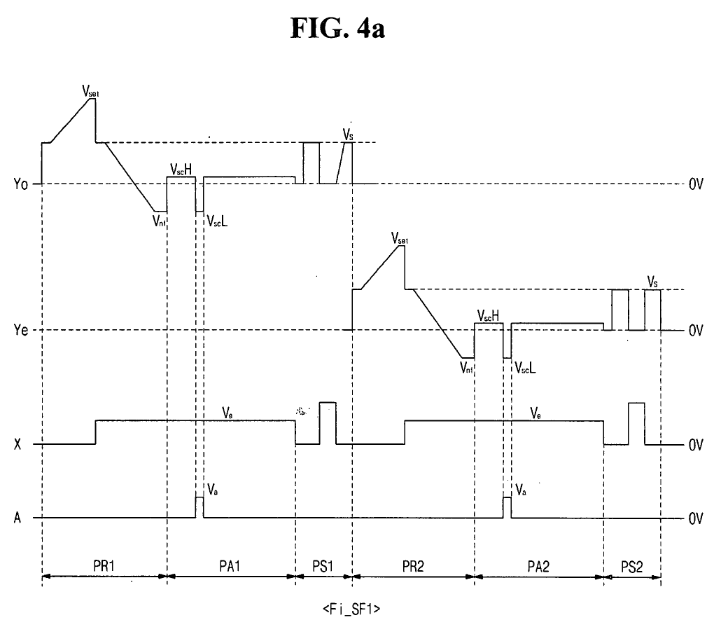

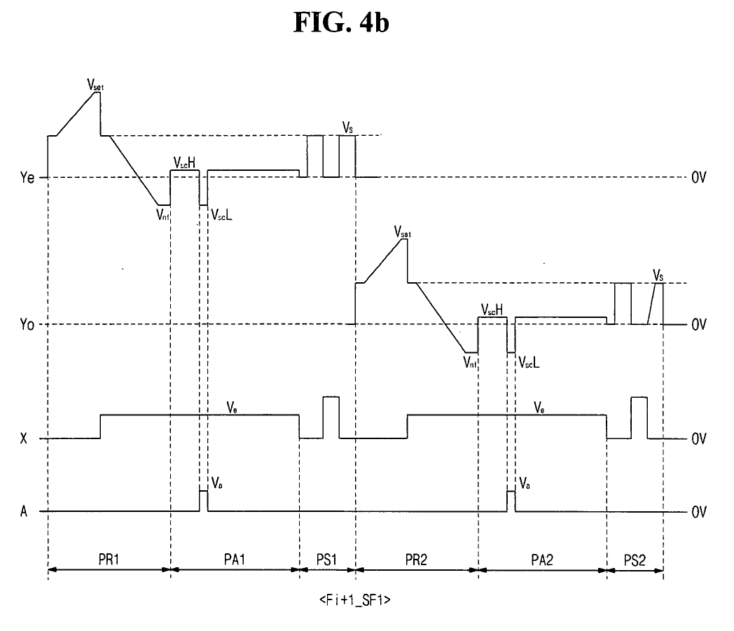

FIG. 4a and FIG. 4b are driving waveforms supplied to each sub-field in a plasma display device according to a second embodiment of the present invention.

The driving waveforms of the plasma display device of FIGS. 4a and 4b correspond to those of FIGS. 3a and 3b except that the first and second discharge cell groups are alternately scanned with respect to each frame. Therefore, a detailed description thereof has been omitted.

Referring to FIG. 4a, a weak discharge occurs by sustain pulses supplied to the first discharge cell group G1 including the odd-numbered scan electrodes Yo and odd-numbered sustain electrodes Xo for the first sustain period PS1 of a low level gray scale sub-field, e.g. the first sub-field SF1, included in the ith frame Fi. A strong discharge occurs by the sustain pulses supplied to the second discharge cell group G2 including the even-numbered scan electrodes Ye and even-numbered sustain electrodes Xe for the second sustain period PS2.

Referring to FIG. 4b, a strong discharge occurs by sustain pulses supplied to the second discharge cell group G2 including the even-numbered scan electrodes Ye and even-numbered sustain electrodes Xe for the first sustain period PS1 of a low level gray scale sub-field, e.g. the first sub-field SF1, included in the (i+1)st frame F(i+1). A weak discharge occurs by the sustain pulses supplied to the first discharge cell group G1 including the odd-numbered scan electrodes Yo and odd-numbered sustain electrodes Xo for the second sustain period PS2.

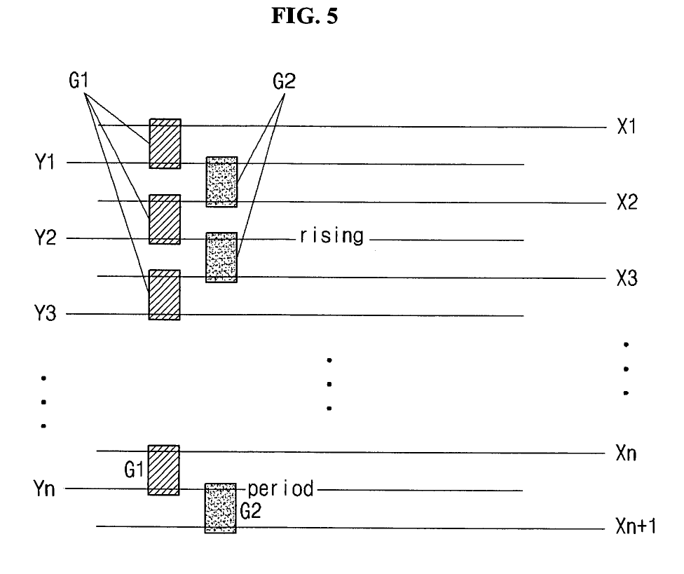

FIG. 5 illustrates electrode lines of an Alternate LIghting of Surface (ALIS) method plasma display device according to a third embodiment of the present invention.

Referring to FIG. 5, the scan electrodes Y1 to Yn are arranged between the sustain electrodes X1 to Xn+1. In this case, high-brightness images can be implemented because 2n discharge cells are formed between the scan electrodes Y1 to Yn and the sustain electrodes X1 to Xn+1.

On the other hand, the first to the nth sustain electrodes X1 to Xn and the first and nth scan electrodes Y1 to Yn constitute discharge cells ([X1,Y1][X2,Y2][Xn,Yn]), which are grouped to form a first discharge cell group G1. The discharge cells included in the first X discharge cell group G1 are defined by the scan electrodes Y1 to Yn and the sustain electrodes X1 to Xn, each of which is located above each of the scan electrodes Y1 to Yn.

The second to the n+1th sustain electrodes X2 to Xn+1 and the first and nth scan electrodes Y1 to Yn constitute discharge cells ([X2,Y1][X3,Y2][Xn+1,Yn]), which are grouped to form a second discharge cell group G2. The discharge cells included in the second discharge cell group G2 are defined by the scan electrodes Y1 to Yn and the sustain electrodes X2 to Xn+1, each of which is located below each of the scan electrodes Y1 to Yn.

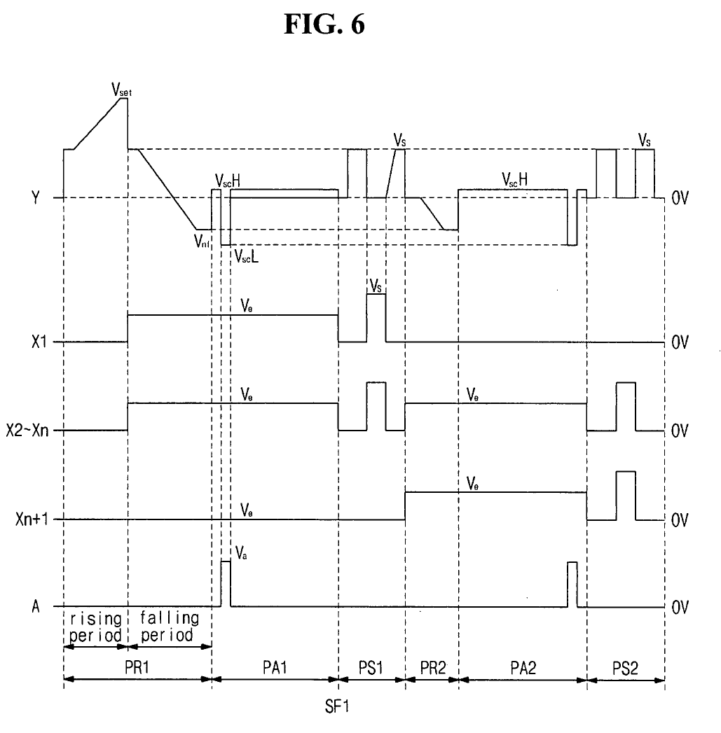

These first and second discharge cell groups G1 and G2 are each driven separately to perform a reset discharge, an address discharge, and a sustain discharge. A more detailed description follows in conjunction with FIG. 6.

Referring to FIG. 6, a low gray scale sub-field, e.g. the first sub-field, includes a first reset period PR1, a first address period PA1, a first sustain period PS1, a second reset period PR2, a second address period PA2, and a second sustain period PS2.

The first reset period PR1 is a time period for initializing all of the discharge cells included in the first discharge cell group G1. The first address period PA1 is a time period for addressing the discharge cells included in the first discharge cell group G1, including discharge cells to be lit and discharge cells not to be lit divided among the discharge cells included in the first discharge cell group G1.

The first sustain period PS1 is a time period for creating a prescribed number of sustain discharges at the discharge cells selected (addressed) for the first address period PA1. The number of sustain discharges can be adjusted depending on a designer's intention.

The electrode Y and the electrodes X1 to Xn are alternately supplied with ramp-waveform sustain pulses which have a high level voltage (‘Vs’ in FIG. 6) and a low level voltage (‘0V’ in FIG. 6) for the first sustain period PS1, wherein a slope from the high level voltage to the low level voltage or from the low level voltage to the high level voltage is a constant. Accordingly, a sustain discharge occurs between the electrode Y and the electrodes X1 to Xn of the discharge cells to be lit. The rising slope of the last sustain pulse of the sustain pulses supplied to the electrode Y, i.e. the slope from the low level voltage 0V to the high level voltage Vs, is smaller than the rising slope of the other sustain pulses. Thus, if the voltage supplied to the discharge cells selected for the address period exceeds a firing voltage between the electrode Y and the electrodes X1 to Xn, then a weak sustain discharge occurs between the electrode Y and the electrodes X1 to Xn. In this case, the amount of light generated during the first sustain period PS1 is relatively small, because the last sustain discharge among the sustain discharges occurring between the electrode Y and the electrodes X1 to Xn is weak.

The second reset period PR2 is a time period for initializing all of the discharge cells included in the second discharge cell group G2. The second address period PA2 is a time period for addressing the discharge cells included in the second discharge cell group G2, including discharge cells to be lit and discharge cells not to be lit divided among the discharge cells included in the second discharge cell group G2.

The second sustain period PS2 is a time period for creating a prescribed number of sustain discharges at the discharge cells selected (addressed) for the second address period PA2. The initialization and addressing is not performed at the first discharge cell group G1 for the second reset period PR2 and second address period PA2, respectively.

The electrode Y and the electrodes X2 to Xn+1 are alternately supplied with ramp-waveform sustain pulses which have a high level voltage (‘Vs’ in FIG. 6) and a low level voltage (‘0V’ in FIG. 6), for the second sustain period PS2, wherein a slope from the high level voltage to the low level voltage or from the low level voltage to the high level voltage is a constant. Accordingly, a sustain discharge occurs between the electrode Y and the electrodes X2 to Xn+1 of the discharge cells to be lit. The rising slope of the last sustain pulse of the sustain pulses supplied to the electrode Y, i.e. the slope from the low level voltage 0V to the high level voltage Vs, is equal to the rising slope of the other sustain pulses. Thus, if the voltage supplied to the discharge cells selected for the second address period PA2 exceeds a firing voltage between the electrode Y and the electrodes X2 to Xn+1, then a sustain discharge occurs between the electrode Y and the electrodes X2 to Xn+1. The sustain discharge at the second sustain period PS2 is greater than the sustain discharge at the first sustain period PS1. Therefore, the amount of light generated during the second sustain period PS2 is greater than the amount of light generated during the first sustain period PS1.

As described above, in the plasma display device according to an embodiment of the present invention, there is a difference in the amount of light generated during a first and a second sustain periods of each sub-field including first and second sustain periods. Therefore, the plasma display device and the driving method thereof according to an embodiment of the present invention has improved low gray scale representation as compared to the prior art.

The foregoing exemplary embodiments and aspects of the present invention are merely exemplary and are not to be construed as limiting the present invention. The present teaching can be readily applied to other types of devices. Also, the description of the exemplary embodiments of the present invention is intended to be illustrative, and not to limit the scope of the claims, and many alternatives, modifications, and variations will be apparent to those skilled in the art.

What is claimed is:

1. A method of driving a plasma display device including a plurality of first electrodes, a plurality of second electrodes, a plurality of third electrodes arranged to intersect the first and the second electrodes, and a plurality of discharge cells divided into a first discharge cell group and a second discharge cell group, the plasma display device representing a gray scale using a unit frame consisting of a combination of a plurality of sub-fields, the method comprising:
a first address step of selecting discharge cells to be lit from the first discharge cell group;
a first sustain step of creating sustain discharges in the discharge cells selected in the first address step;
a second address step of selecting discharge cells to be lit from the second discharge cell group; and
a second sustain step of creating sustain discharges in the discharge cells selected in the second address step;
wherein respective rising slopes of a last sustain pulse supplied to the first and the second electrodes in each of the first and second sustain steps are different from each other.

2. The method of claim 1, wherein the first discharge cell group comprises discharge cells defined by first odd-numbered electrodes among the first electrodes, and the second discharge cell group comprises discharge cells defined by first even-numbered electrodes among the first electrodes.

3. The method of claim 1, wherein the first discharge cell group comprises discharge cells defined by the first electrodes and the second electrodes, each of which is located above each of the first electrodes, and the second discharge cell group comprises discharge cells defined by the first electrodes and the second electrodes, each of which is located below each of the first electrodes.

4. The method of claim 2, wherein:
the rising slope of the last sustain pulse supplied to either the first electrodes or the second electrodes is smaller than a rising slope of the other sustain pulses, for the first sustain step, and the rising slope of the last sustain pulse supplied to either the first electrodes or the second electrodes is equal to a rising slope of the other sustain pulses, for the second sustain step.

5. The method of claim 2, wherein:
the rising slope of the last sustain pulse supplied to either the first electrodes or the second electrodes is equal to a rising slope of the other sustain pulses, for the first sustain step, and
the rising slope of the last sustain pulse supplied to either the first electrodes or the second electrodes is smaller than a rising slope of the other sustain pulses, for the second sustain step.

6. The method of claim 3, wherein:
the rising slope of the last sustain pulse supplied to either the first electrodes or the second electrodes is smaller than a rising slope of the other sustain pulses, for the first sustain step, and
the rising slope of the last sustain pulse supplied to either the first electrodes or the second electrodes is equal to a rising slope of the other sustain pulses, for the second sustain step.

7. The method of claim 3, wherein:
the rising slope of the last sustain pulse supplied to either the first electrodes or the second electrodes is equal to a rising slope of the other sustain pulses, for the first sustain step, and
the rising slope of the last sustain pulse supplied to either the first electrodes or the second electrodes is smaller than a rising slope of the other sustain pulses, for the second sustain step.

8. The method of claim 1, further comprising:
a first reset step of initializing the first discharge cell group prior to the first address step; and
a second reset step of initializing the second discharge cell group prior to the second address step.

9. A method of driving a plasma display device including a plurality of first electrodes, a plurality of second electrodes, a plurality of third electrodes arranged to intersect the first and the second electrodes, and a plurality of discharge cells divided into a first discharge cell group and a second discharge cell group, the plasma display device representing a gray scale using a unit frame consisting of a combination of a plurality of sub-fields, wherein:
a jth sub-field (where, j is a natural number) among a plurality of sub-fields included in an ith frame (where, i is a natural number) comprises a first sustain period in which a first amount of light is generated and a second sustain period in which a second amount of light is generated, and
a jth sub-field among a plurality of sub-fields included in a i+1 th frame comprises a first sustain period in which the second amount of light is generated and a second sustain period in which the first amount of light is generated.

10. The method of claim 9, wherein:
the jth sub-field of the ith frame comprises:
a first address step of selecting discharge cells to be lit from the first discharge cell group;
a first sustain step of creating sustain discharges in the discharge cells selected in the first address step, during the first sustain period;
a second address step of selecting discharge cells to be lit from the second discharge cell group; and
a second sustain step of creating sustain discharges in the discharge cells selected in the second address step, during the second sustain period, and
the jth sub-field of the i+1th frame comprises:
a first address step of selecting discharge cells to be lit from the second discharge cell group;
a first sustain step of creating sustain discharges in the discharge cells selected in the first address step, during the first sustain period;
a second address step of selecting discharge cells to be lit from the first discharge cell group; and
a second sustain step of creating sustain discharges in the discharge cells selected in the second address step, during the second sustain period.

11. The method of claim 10, wherein the first discharge cell group comprises discharge cells defined by first odd-numbered electrodes among the first electrodes, and the second discharge cell group comprises discharge cells defined by first even-numbered electrodes among the first electrodes.

12. The method of claim 10, wherein the first discharge cell group comprises discharge cells defined by the first electrodes and the second electrodes, each of which is located above each of the first electrodes, and the second discharge cell group comprises discharge cells defined by the first electrodes and the second electrodes, each of which is arranged below each of the first electrodes.

13. The method of claim 11, wherein:
a rising slope of a last sustain pulse supplied to either the first electrodes or the second electrodes during the first sustain step is smaller than a rising slope of the other sustain pulses, and
a rising slope of the last sustain pulse supplied to either the first electrodes or the second electrodes during the second sustain step is equal to a rising slope of the other sustain pulses.

14. The method of claim 12, wherein:
a rising slope of the last sustain pulse supplied to either the first electrodes or the second electrodes during the first sustain step is smaller than a rising slope of the other sustain pulses, and
a rising slope of the last sustain pulse supplied to either the first electrodes or the second electrodes during the second sustain step is equal to a rising slope of the other sustain pulses.

15. The method of claim 10, further comprising:
a first reset step of initializing the first discharge cell group prior to the first address step; and
a second reset step of initializing the second discharge cell group prior to the second address step.

16. A plasma display device comprising:
a Plasma Display Panel (PDP) including a plurality of first electrodes, a plurality of second electrodes, a plurality of third electrodes arranged to intersect the first and the second electrodes, and a plurality of discharge cells divided into a first discharge cell group and a second discharge cell group;
a controller dividing a frame into a plurality of sub-fields, the controller controlling at least one of the plurality of sub-fields to have first and second sustain periods; and
a driver supplying sustain pulses to the plurality of the first electrodes, respective rising slopes of a last sustain pulse supplied to the first electrode in each of the first and second steps are different from each other.

17. The plasma display device of claim 16, wherein the first discharge cell group comprises discharge cells defined by first odd-numbered electrodes among the first electrodes, and the second discharge cell group comprises discharge cells defined by first even-numbered electrodes among the first electrodes.

18. The plasma display device of claim 16, wherein the first discharge cell group comprises discharge cells defined by the first electrodes and the second electrodes, each of which is arranged above each of the first electrodes, and the second discharge cell group comprises discharge cells defined by the first electrodes and the second electrodes, each of which is arranged below each of the first electrodes.

19. The plasma display device of claim 16, wherein the driver supplies the last sustain pulse having a rising slope equal to a rising slope of the other sustain pulses to the first electrodes for the first sustain step, and supplies the last sustain pulse having a rising slope smaller than a rising slope of the other sustain pulses to the first electrodes for the second sustain step.

20. The plasma display device of claim 16, wherein the driver supplies the last sustain pulse having a rising slope smaller than a rising slope of the other sustain pulses to the first electrodes for the first sustain step, and supplies the last sustain pulse having a rising slope equal to a rising slope of the other sustain pulses to the first electrodes for the second sustain step.
